(19) United States
(12) Patent Application Publication
(10) Pub. No.: US 2016/0229302 A1
(43) Pub. Date: Aug. 11, 2016

(54) APPARATUS AND METHOD FOR POWER CONTROL

(71) Applicant: MANDO CORPORATION, Pyeongtaek-si (KR)

(72) Inventor: Young Ok LEE, Seongnam-si (KR)

(21) Appl. No.: 15/012,853

(22) Filed: Feb. 2, 2016

(30) Foreign Application Priority Data
Feb. 6, 2015 (KR) 10-2015-0018747

(51) Int. Cl. B60L 11/18

(52) U.S. Cl. CPC B60L 11/1809; B60L 11/18

(57) ABSTRACT

A method and an apparatus control power of a vehicle including a main battery, an auxiliary battery, and an electric load. The Apparatus includes: a State Of Charge (SOC) detection unit configured to detect an SOC of the main battery and an SOC of the auxiliary battery, an allowable power calculation unit configured to calculate an allowable power of the main battery, a charging/discharging power calculation unit configured to calculate a charging/discharging power of the auxiliary battery, a first electric load power calculation unit configured to calculate a first electric load power, an operation control unit configured to control an operation of an electric load, a second electric load power calculation unit configured to calculate a second electric load power, and a charging/discharging control unit configured to control charging or discharging of the auxiliary battery.

### CROSS-REFERENCE TO RELATED APPLICATION

This application claims priority from and the benefit under 35 U.S.C. §119(a) of Korean Patent Application No. 10-2015-0018747, filed on Feb. 6, 2015, which is hereby incorporated by reference for all purposes as if fully set forth herein.

### BACKGROUND OF THE INVENTION

1. Field of the Invention

The present disclosure relates to a technology for controlling the electric power of a vehicle, including a main battery, an auxiliary battery, and an electric load. More particularly, the present disclosure relates to a technology for controlling the electric power of a vehicle, including a main battery, an auxiliary battery, and an electric load, based on the State Of Charge (SOC) of a main battery and an auxiliary battery, the charging/discharging power of the auxiliary battery, and the power consumption of an electric load.

2. Description of the Prior Art

In general, in order to enhance a driver's convenience, an electric load including an electric heating seat, a wiper, a heater, a heating wire, an air conditioner, an audio device, a side mirror, a fog lamp, a head lamp, a brake lamp, an emergency lamp, an indoor lamp, windows, and an Electric Power Steering (EPS) device is installed in a vehicle.

Generally, the electric load uses the power of a main battery to perform operations. Further, when the power of the main battery is insufficient, the electric load may use the power of the auxiliary battery to perform normal operations.

However, the frequent switching between the charging and discharging of the auxiliary battery according to the power of the electric load executed by driver's requests may shorten the life span of the auxiliary battery.

Further, the main battery may be completely discharged according to the power of the electric load executed by a driver's request.

### SUMMARY OF THE INVENTION

On this background, an aspect of the present disclosure is to provide a power control apparatus and method for controlling power to prevent frequent switching operations between charging and discharging of an auxiliary battery.

Another aspect of the present disclosure is to provide a power control apparatus and method for controlling power to prevent complete discharging of a main battery.

In order to solve the above-described problems, an aspect of the present disclosure provides a power control apparatus for controlling power of a vehicle including a main battery, an auxiliary battery, and an electric load, the power control apparatus including: a State Of Charge (SOC) detection unit configured to detect an SOC of the main battery and an SOC of the auxiliary battery; an allowable power calculation unit configured to calculate an allowable power of the main battery, based on the SOC of the main battery; a charging/discharging power calculation unit configured to calculate a charging/discharging power of the auxiliary battery performing a charging/discharging operation; a first electric load power calculation unit configured to calculate a first electric load power, which is power of an electric load, execution of which has been requested by a driver; an operation control unit configured to control an operation of an electric load, execution of which has been requested based on the allowable power, the charging/discharging power, and the first electric load power; a second electric load power calculation unit configured to calculate a second electric load power, which is power of an electric load, execution of which has been requested by the operation control unit; and a charging/discharging control unit configured to control charging or discharging of the auxiliary battery, based on the SOC of the auxiliary battery, the allowable power, the charging/discharging power, and the second electric load power.

Another aspect of the present disclosure provides a method for power control, the method including: installing a main battery, an auxiliary battery, and an electric load in parallel in a vehicle; detecting a State Of Charge (SOC) of the main battery and an SOC of the auxiliary battery; controlling charging of the auxiliary battery based on the SOC of the auxiliary battery; calculating an allowable power of the main battery, based on the SOC of the main battery; calculating a charging/discharging power of the auxiliary battery performing a charging/discharging operation; calculating a first electric load power, which is power of an electric load, execution of which has been requested by a driver; controlling an operation of an electric load, execution of which has been requested based on the allowable power, the charging/discharging power, and the first electric load power; calculating a second electric load power, which is power of an electric load, execution of which has been requested by the operation control unit; and controlling charging or discharging of the auxiliary battery, based on the allowable power, the charging/discharging power, and the second electric load power.

The apparatus and method as described above can control electric power, based on the SOC of the main battery and the auxiliary battery, the charging/discharging power of the auxiliary battery, and the power consumption of the electric load. Therefore, the apparatus and method can prevent frequent switching operations between charging and discharging, thereby preventing reduction of the life span of the auxiliary battery and complete discharge of the main battery.

### BRIEF DESCRIPTION OF THE DRAWINGS

The above and other objects, features and advantages of the present invention will be more apparent from the following detailed description taken in conjunction with the accompanying drawings, in which:

FIG. 1 illustrates a configuration of a power control apparatus according to an embodiment of the present disclosure;

FIG. 2 illustrates an example for describing the operation of a power control apparatus according to an embodiment of the present disclosure;

FIG. 3 illustrates another example for describing the operation of a power control apparatus according to an embodiment of the present disclosure;

FIGS. 4A to 4C illustrate an example for describing the operation of an operation control unit according to an embodiment of the present disclosure;

FIGS. 5A to 5C illustrate another example for describing the operation of an operation control unit according to an embodiment of the present disclosure;

FIG. 6 illustrates a configuration of a power control apparatus according to another embodiment of the present disclosure;

FIG. 7 illustrates an example for describing the operation of a power control apparatus according to another embodiment of the present disclosure; and

FIG. 8 illustrates another example for describing the operation of a power control apparatus according to another embodiment of the present disclosure.

### DETAILED DESCRIPTION OF THE EXEMPLARY EMBODIMENTS

Hereinafter, exemplary embodiments of the present invention will be described with reference to the accompanying drawings. In the description of the elements of the present invention, terms “first”, “second”, “A”, “B”, “(a)”, “(b)” and the like may be used. These terms are merely used to distinguish one structural element from other structural elements, and a property, an order, a sequence and the like of a corresponding structural element are not limited by the term. It should be noted that if it is described in the specification that one component is “connected,” “coupled” or “joined” to another component, a third component may be “connected,” “coupled,” and “joined” between the first and second components, although the first component may be directly connected, coupled or joined to the second component.

Further, for convenience of description, the operation control unit is described to include an electric load operation control unit and a motor operation control unit. However, it should be understood that the operations of the two control units may be performed by a single operation control unit. Further, for convenience of description, the charging/discharging control unit is also described to include a charging control unit and a discharging control unit. However, it should be understood that the operations of the two control units may be performed by a single charging/discharging control unit.

A power control apparatus for controlling power of a vehicle including a main battery, an auxiliary battery, and an electric load according to an embodiment of the present disclosure may include: a State Of Charge (SOC) detection unit configured to detect an SOC of the main battery and an SOC of the auxiliary battery; an allowable power calculation unit configured to calculate an allowable power of the main battery, based on the SOC of the main battery; a charging/discharging power calculation unit configured to calculate a charging/discharging power of the auxiliary battery performing a charging/discharging operation; a first electric load power calculation unit configured to calculate a first electric load power, which is power of an electric load, execution of which has been requested by a driver; an operation control unit configured to control an operation of an electric load, execution of which has been requested based on the allowable power, the charging/discharging power, and the first electric load power; a second electric load power calculation unit configured to calculate a second electric load power, which is power of an electric load, execution of which has been requested by the operation control unit; and a charging/discharging control unit configured to control charging or discharging of the auxiliary battery, based on the SOC of the auxiliary battery, the allowable power, the charging/discharging power, and the second electric load power.

The electric load is a device, which is operated by electricity and provides conveniences to the driver, and includes an electric heating seat, a wiper, a heater, a heating wire, an air conditioner, an audio device, an electronic side mirror, a fog lamp, a head lamp, a brake lamp, an emergency lamp, an indoor lamp, electronic windows, and an Electric Power Steering (EPS) device installed in a vehicle. However, in the following description, for convenience of the description, the electric load is limitedly described via representative electric loads of three levels (including a heater as an electric load of the low level, a wiper as an electric load of the middle level, and a steering device as an electric load of the high level), in consideration of the power consumption and the influence on the driving performance.

In a power control apparatus according to an embodiment of the present disclosure, the electric load may be applied at two or more levels, and may have a level changing according to a configured criterion. However, regardless of the difference changing according to the criterion, a power control apparatus according to an embodiment of the present disclosure may operate. Therefore, it should be included in the range of the present disclosure.

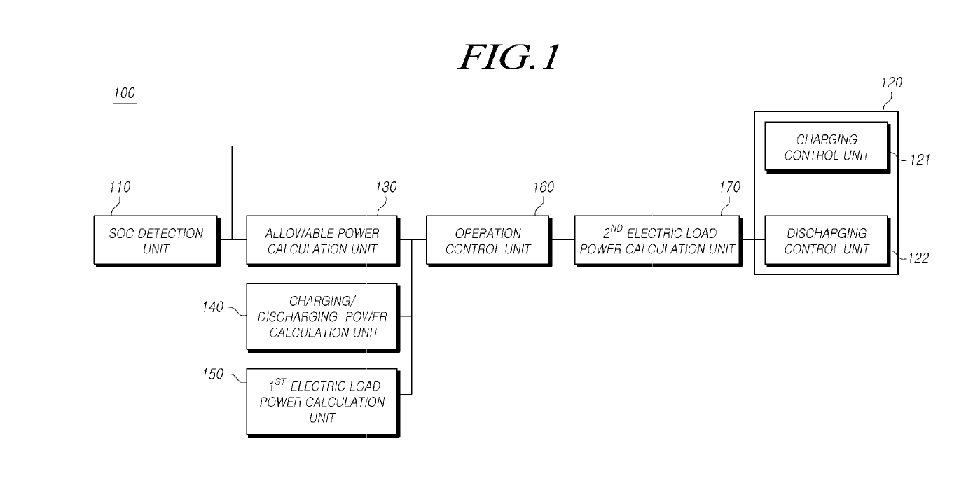

FIG. 1 illustrates a configuration of a power control apparatus according to an embodiment of the present disclosure.

Referring to FIG. 1, a power control apparatus 100 according to an embodiment of the present disclosure may include a State Of Charge (SOC) detection unit 110 configured to detect the SOC of a main battery and the SOC of an auxiliary battery.

For example, the SOC detection unit 110 may detect the SOC of the main battery and the auxiliary battery by a method of State Of Charge based on current (SOCi) or State Of Charge based on voltage (SOCv) according to a predetermined condition using a simple equivalent circuit model for the main battery and the auxiliary battery.

The power control apparatus 100 according to an embodiment of the present disclosure may include an allowable power calculation unit 130 configured to calculate the allowable power of the main battery based on the detected SOC of the main battery.

For example, the allowable power calculation unit 130 may calculate the allowable power as a value proportional to the calculated SOC of the main battery.

The allowable power calculation unit 130 may calculate the allowable power, based on experimental data on a power use time and the SOC of the main battery.

As an example, in the case of two main batteries having the same value, if the power use time of a first main battery having an SOC of 1,000 [Wh] is calculated as five hours, the allowable power calculation unit 130 may obtain a power of 200 [W] as the allowable power of the first main battery.

Otherwise, if the power use time of a second main battery having an SOC of 500 [Wh] is calculated as five hours, the allowable power calculation unit 130 may obtain a power of 100 [W] as the allowable power of the second main battery.

In the example, the five hours may be a time for which a driver can drive by one charging. However, this time may change according to experimental values.

In addition, the allowable power calculation unit 130 may predict the available time, based on the SOC of the main battery.

For example, if the allowable power calculation unit 130 obtains five hours as the available time for a battery having a power of 1,000 [Wh] by the SOC thereof, the allowable power calculation unit 130 may obtain 2.5 hours as the available time of a battery having an SOC of 500 [Wh]. The allowable power calculation unit 130 may calculate an allowable power proportional to the calculated available time.

For example, the allowable power calculation unit 130 may obtain an allowable power of 200 [W] for the first main battery, the available time of which has been calculated as five hours, and may obtain an allowable power of 100 [W] for the second main battery, the available time of which has been calculated as 2.5 hours.

The power control apparatus 100 according to an embodiment of the present disclosure may include a charging/discharging power calculation unit 140 configured to calculate the charging/discharging power of the auxiliary battery performing the charging/discharging operation.

The charging/discharging power calculation unit 140 can calculate the power of the auxiliary battery, using the measured voltage and current of the auxiliary battery. Since the voltage used to calculate the power is the same as the voltage measured by a voltage sensor of a converter used to fix the voltage of the electric load to a constant voltage, the apparatus of the present disclosure is advantageous in that it does not require an additional voltage sensor. Further, since the current used to calculate the power is the same as the current measured by a current sensor of a converter used for constant-current charge of the auxiliary battery, the apparatus of the present disclosure is advantageous in that it does not require an additional current sensor.

The power control apparatus 100 according to an embodiment of the present disclosure may include a first electric load power calculation unit 150 configured to calculate a first electric load power, which is power of an electric load, execution of which has been requested by the driver.

The first electric load power calculation unit 150 may calculate the power of an electric load, execution of which has been requested, without operating the electric load, based on power data of the electric load previously measured through an experiment.

For example, based on data obtained through previous experiments, including experiment data 1 showing that the power consumption of a heater operating at a first level, a second level, and a third level has a value of 20 [W], 40 [W], and 60 [W], respectively, experiment data 2 showing that the power consumption of a wiper operating at a first level and a second level has a value of 10 [W] and 20 [W], respectively, experiment data 3 showing that the power consumption of a steering device operating according to a steering angle by a steering gear has a value of 0 [W] to 50 [W], the first electric load power calculation unit 150 may calculate the power of the execution-requested operation even though the heater, wiper, or steering device does not operate. In other words, if the driver requests the heater to be executed at the second level, the wiper at the first level, and the steering gear at the maximum steering angle, the first electric load power calculation unit 150 can calculate, without performing an operation, 40 [W] as the power consumption of the heater, 10 [W] as the power consumption of the wiper, and 50 [W] as the power consumption of the steering device.

This is because the power consumption according to each operation of the electric load may have a constant value and the power consumption of the electric load may thus always have the same value as previously obtained data.

The power control apparatus 100 according to an embodiment of the present disclosure may include an operation control unit 160 configured to control the operation of the electric load, execution of which has been requested based on the allowable power calculated by the allowable power calculation unit 130, the charging/discharging power calculated by the charging/discharging power calculation unit 140, and the first electric load power calculated by the first electric load power calculation unit 150.

When a sum of the charging/discharging power and the first electric load power exceeds the allowable power, the operation control unit 160 may control the operation of the electric load, execution of which has been requested.

For example, each electric load item may be allocated a priority in consideration of the influence on the driving performance and the power consumption.

In this regard, when the available time does not exceed a predetermined reference, the operation control unit 160 may first limit the power consumption of an electric load item having the lowest priority.

For example, in the case of an electric load configured by a heater, a wiper, and a steering device, the heater may have the largest influence on the power consumption while the steering device and wiper may have smaller influences thereon. In contrast, the heater and wiper may have small influences on the driving performance while the steering device may have a large influence on the driving performance. On the assumption described above, in consideration of the influences on the power consumption and driving performance, the heater may be configured to have the lowest priority, the wiper may be configured to having a middle priority, and the steering device may be configured to have the highest priority.

The priority level described above implies the sequence of reducing the power of electric load items when it is necessary to reduce the power of the electric load, and implies that, when the power reduction is inevitable, it is effective in various viewpoints including the safety of a driver to firstly reduce the power of an electric load item having the lowest priority. In this regard, reduction of power consumption of an electric load item having a high priority may threaten the driver's safety.

Therefore, when the sum of the charging/discharging power and the first electric load power exceeds the allowable power, the operation control unit 160 may firstly reduce the power consumption of the heater, which is an electric load item having the lowest priority. If a difference between the allowable power and the sum of the charging/discharging power and the first electric load power is larger than power saved by controlling the heater, the operation control unit 160 may reduce the power consumption of the wiper, which has the next highest priority to that of the heater.

The operation control unit 160 may reduce the power consumption by controlling the operation of the electric load item, execution of which has been requested, by at least one method among lowering of the operation level and reduction of the operation time.

In regard to the lowering of the operation level, for example, if a driver requests execution of the heater at a third level of a high temperature, the operation control unit 160 may operate the heater at a second level which corresponds to a temperature lower than that of the third level, thereby reducing the power consumed by the heater. Likewise, if the driver requests execution of the wiper at a second level corresponding to a fast speed, the operation control unit 160 may operate the wiper at a first level which corresponds to a speed slower than that of the second level, thereby reducing the power consumed by the wiper.

In regard to the reduction of the operation time, for example, if a driver requests execution of the heater at a third level of a high temperature, the operation control unit 160 may operate the heater at the third level for discrete time, thereby reducing the power consumed by the heater. This implies that the operation control unit 160 operates the heater at the third level but operates the heater at predetermined time intervals, thereby reducing the power consumed by the heater. That is, the operation control unit 160 may operate the heater at the third level for five seconds, turn off the heater for five seconds, and then operate the heater at the third level, thereby reducing the power consumed by the heater.

Further, the operation control unit 160 may control the electric load to operate for discrete time, thereby reducing the power consumption. For example, the operation control unit may control the operation time points of the electric load to be dispersed, thereby reducing the power consumed by the electric load.

For example, when the heater and the wiper operate for discrete time to reduce the power consumption, the operation control unit 160 may operate the heater at an interval of five seconds, such as 0 to 5 seconds, 10 to 15 seconds, or 20 to 25 seconds, and may operate the wiper at an interval of five seconds, such as 5 to 10 seconds, 15 to 20 seconds, or 25 to 30 seconds, thereby reducing the power consumption by the electric load.

The five seconds is just an example, and may be changed according to the characteristic of each load. However, the operation control unit 160 may control the electric load to disperse the operation time points thereof as in the example described above.

The power control apparatus 100 according to an embodiment of the present disclosure may include a second electric load power calculation unit 170 configured to calculate a second electric load power, which is power of an electric load executed by the operation control unit 160.

The second electric load power calculation unit 170 may calculate, based on data previously obtained from an experiment, the power consumption of an electric load according to a control of the operation control unit 160. The data obtained from an experiment may be the same as the experimental data used as a basis for calculation of the first electric load power by the first electric load power calculation unit 150.

For example, if the operation control unit 160 has operated the heater at the first level in spite of the driver's request for operation of the heater at the third level, the second electric load power calculation unit may calculate the power consumption of the heater, based on the experimental data at the time when the heater operates at the first level.

However, the second electric load power calculated by the second electric load power calculation unit 170 is always lower than or equal to the first electric load power calculated by the first electric load power calculation unit 150. Further, the second electric load power may always have a value larger than or equal to the power consumption of an electric load item having the highest priority.

A power control apparatus 100 according to an embodiment of the present disclosure may include a charging/discharging control unit 120 for controlling charging or discharging of the auxiliary battery, based on the SOC of the auxiliary battery, the allowable power of the main battery, the charging/discharging of the auxiliary battery, and the second electric load power.

The charging/discharging control unit 120 may include a charging control unit 121 configured to control the auxiliary battery to be charged when the SOC of the auxiliary battery is lower than a pre-configured value, and a discharging control unit 122 configured to control the auxiliary battery to be discharged when the sum of the second electric load power and the charging/discharging power of the auxiliary battery exceeds the allowable power of the main battery.

The charging or discharging of the battery may be performed or controlled by a Micro Controller Unit (MCU). A more detailed description thereof is not closely related to the idea of the present invention and will thus be omitted.

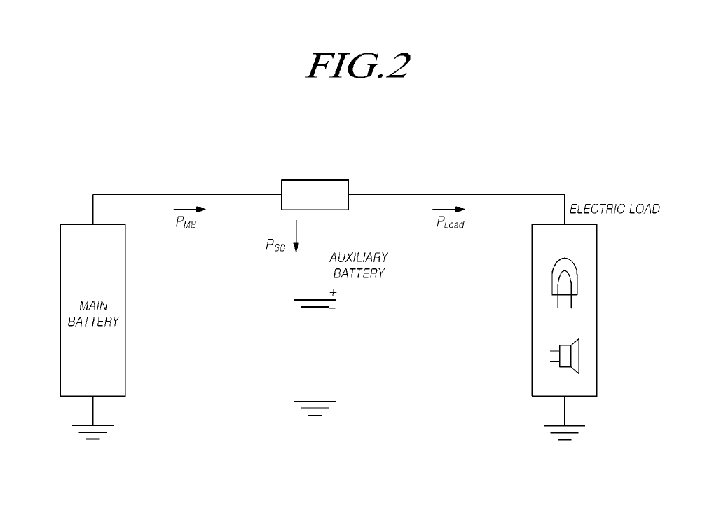

FIG. 2 illustrates an example for describing the operation of a power control apparatus according to an embodiment of the present disclosure.

Referring to FIG. 2, in a vehicle according to an embodiment of the present disclosure, a main battery, an auxiliary battery, and an electric load may be connected in parallel to each other.

The SOC of the main battery corresponds to the power amount of the main battery. That is, if the power amount of the main battery based on the SOC of the main battery is 1,000 [Wh], power of 1,000 [W] can be used for one hour.

If the main battery is completely discharged, an electric load using the power of the main battery is unable to operate. Therefore, an auxiliary battery is used to operate the electric load even after the main battery is completely discharged. For example, when the main battery is completely discharged and has a power amount by the SOC of 0 [Wh], the auxiliary battery may be discharged to supply electric power to the electric load to enable the electric load to operate.

Referring to FIG. 2, a power relation as described above may be established between the power P_{MB} of the main battery, the charging/discharging power P_{SB} of the auxiliary battery, and the power P_{LOAD} of the electric load. The direction of the power P_{MB} of the main battery and the power P_{LOAD} of the electric load is always constant as shown in FIG. 2. However, the direction of the charging/discharging power P_{SB} of the auxiliary battery may change according to the charging or discharging operation of the auxiliary battery.

Further, the charging/discharging power P_{SB} shown in FIG. 2 corresponds to a power according to the charging operation of the auxiliary battery. A unidirectional converter may be used for the power P_{MB} of the main battery and the power P_{LOAD} of the electric load since they are unidirectional. However, the power P_{SB} of the auxiliary battery is bidirectional and thus requires a bidirectional converter. The converters described above are not illustrated in FIG. 2. However, such knowledge is basically required for the understanding of FIG. 2.

Further, according to the electric knowledge of FIG. 2, the power P_{LOAD} of the electric load according to the operation of the electric load and the charging/discharging power P_{SB} of the auxiliary battery according to the charging/discharging operations of the auxiliary battery are controlled by a converter of the electric load and a bidirectional converter of the auxiliary battery, respectively, and the power P_{MB} of the main battery is determined by the sum of the controlled power P_{LOAD} of the electric load and charging/discharging power P_{SB}. This can be expressed by equation (1) below.

P_{Load}+P_{SB}=P_{MB} Equation (1)

In equation (1), P_{SB} has a positive value at the time of charging and a negative value at the time of discharging.

That is, the power P_{LOAD} of the electric load and the charging/discharging power P_{SB} are actively controlled while the power P_{MB} of the main battery is passively controlled by the power P_{LOAD} of the electric load and the charging/discharging power P_{SB}, which have been actively controlled. The polarity of (+) or (−) according to the charging operation or discharging operation of the auxiliary battery may change according to the hardware configuration and is not limited by the basic indication that the polarity of (+) indicates the charging state and the polarity of (−) indicates the discharging state.

The active controlling as described above refers to direct controlling by a micro-controller, and the passive controlling refers to controlling by a result of the direct controlling by the micro-controller.

In the case of application to a power control apparatus according to an embodiment of the present disclosure, the SOC detection unit controls the charging operation of the auxiliary battery by detecting the SOC of the auxiliary battery. Further, based on the SOC of the main battery detected by the SOC detection unit, the allowable power calculation unit calculates the allowable power of the main battery. A method for detecting the SOC may use a voltage value of a battery and the characteristic of the battery.

In addition, the allowable power calculation unit may predict the available time, based on the SOC of the main battery. Thereafter, the allowable power calculation unit calculates an allowable power proportional to the available time.

Thereafter, based on the calculated allowable power of the main battery, the charging/discharging power of the auxiliary battery, and a calculated power consumption of an electric load item, execution of which has been requested by the driver, the operation control unit determines whether to operate the electric load by the value, execution of which has been requested by the driver, or to operate the electric load by reducing the power consumption of the electric load. This is based on a principle that, since the power P_{MB} of the main battery is determined by the power P_{LOAD} of the electric load and the charging/discharging power P_{SB} of the auxiliary battery, the power P_{MB} of the main battery becomes equal to a pre-configured allowable power of the main battery if the power P_{LOAD} of the electric load is determined based on the pre-configured allowable power of the main battery and the charging/discharging power P_{SB}.

As described above, in order to control the power P_{LOAD} of the electric load based on the pre-configured allowable power of the main battery and the charging/discharging power P_{SB}, the electric load may be controlled to reduce the power consumption to be the pre-configured allowable power of the main battery and the charging/discharging power P_{SB}.

In a method of controlling an electrical load, the operation control unit may previously distinguish two or more levels for electric load items, in consideration of influences on the power consumption and driving performance, and manage power of electrical load items except for an electric load item of the highest level in a sequence from an electric load item of the lowest level to the electric load item of the highest level.

In another method of controlling the electrical load, the operation control unit may control the electric load to reduce the power consumption thereof, using at least one method among lowering of the operation level and reduction of the operation time of the electric load. The method of lowering of the operation level is to operate the electric load at a lower operation level other than the operation level, execution of which has been requested by the driver. In contrast, the method of reduction of the operation time is to operate the electric load at the operation level, execution of which has been requested by the driver, but operate the electric load for discrete time instead of continuously operating the electric load.

In another method of controlling the electrical load, the operation control unit may control the electric load items at dispersed time points, thereby reducing the power consumption. In this method, the electric load is operated according to the method described above. However, when two or more electric load items are operated for discrete time, the electric load items are operated while being prevented from operating at the same time.

In another method, for two or more electric load items, the operation control unit performs a control to reduce the power consumption.

As a result, in an electric load including a heater, a wiper, and a steering device, even when the operation control unit controls the operations of electric load items including the heater and the wiper, a sum of the power P_{LOAD} of the operating electric load items and the charging/discharging power P_{SB} of the auxiliary battery performing the charging operation may exceed the allowable power of the main battery. In this event, the charging/discharging control unit switches the auxiliary battery, which is performing the charging operation, into a discharging operation, to prevent the sum of the power P_{LOAD} of the operating electric load items and the charging/discharging power −P_{SB} of the auxiliary battery performing the discharging operation from exceeding the allowable power of the main battery.

By performing the above-described operations, the control apparatus according to an embodiment of the present disclosure can prevent frequent switching operations between charging and discharging of the auxiliary battery. Moreover, the control apparatus according to an embodiment of the present disclosure can maintain the power use time of the main battery.

However, the auxiliary battery may be configured to perform the discharging operation only when the SOC of the auxiliary battery exceeds a pre-configured threshold value, in order to prevent complete discharge of the auxiliary battery.

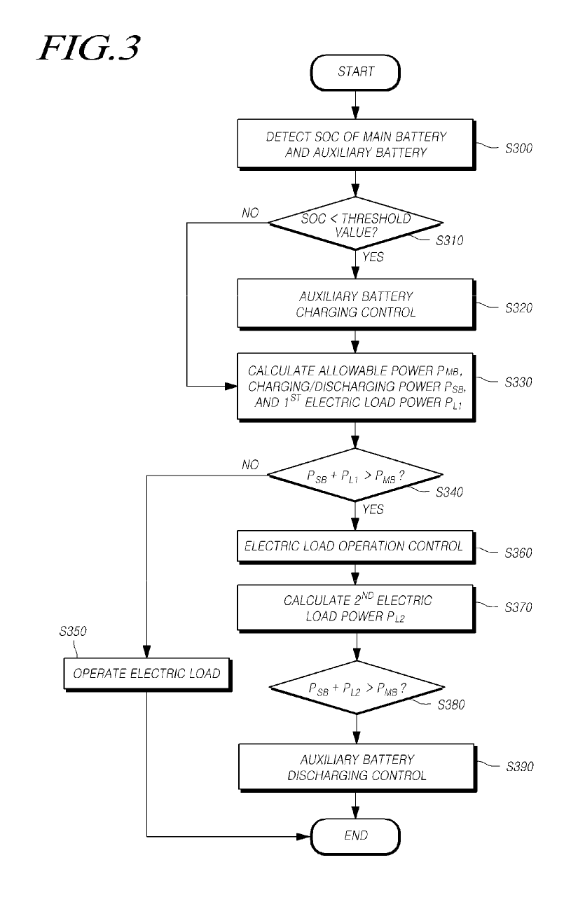

FIG. 3 illustrates another example for describing the operation of a power control apparatus according to an embodiment of the present disclosure.

Referring to FIG. 3, the SOC detection unit of the power control apparatus according to an embodiment of the present disclosure detects the SOC of the main battery and the SOC of the auxiliary battery (S300).

The method for detecting the SOC of a battery includes a voltage measurement method, which indirectly detects the SOC, based on the voltage and characteristics of the battery. In brief, the SOC can be calculated by measuring the output voltage of the battery and comparing the measured output voltage with a discharge curve of the battery. However, the internal resistance of the battery may cause an error. This is because a voltage drop corresponding to a multiple of an output current and the internal resistance of the battery may additionally occur. In the voltage measurement method, the SOC of a battery can be exactly detected by measuring the current of a circuit and correcting the measured value by a corresponding voltage drop value.

In contrast, there is a chemical measurement method used for a battery allowing direct access to a liquid electrolyte, such as an unsealed lead battery. In brief, in the chemical measurement method, the SOC can be calculated by measuring the specific gravity or acidity (hydrogen exponent; pH) of an electrolyte.

Further, there is a current integration method in which the SOC is calculated by measuring and integrating the output current of a battery over the entire working time. However, the current integration method has shortcomings in that a long time measurement may cause a severe error. Therefore, a procedure of correcting a reference value to an SOC of 100% is necessary when it is determined that the battery has been completely charged. To this end, the current integration method is used in parallel with another measurement method.

Finally, there is a pressure measurement method used to measure the SOC of a nickel-hydrogen battery (NiMH). The pressure measurement method uses the characteristic of the nickel-hydrogen battery, the internal pressure of which largely increases as the battery is charged, and can detect the SOC by applying the Peukert's Law.

The charging/discharging control unit of the power control apparatus according to an embodiment of the present disclosure compares the SOC of the auxiliary battery detected in step S300 with a pre-configured threshold value (S310).

The pre-configured threshold value may be set based on a predetermined time for guaranteeing support of the operation of an electric load when the SOC of the auxiliary battery corresponds to the threshold value at the time of a discharge accident of the main battery. That is, at the time of a discharge accident of the main battery, if the electric load is to be operated using the power of the auxiliary battery for long time, the threshold value may be a relatively high value.

As a result of the comparison in step S310, when the SOC is smaller than the pre-configured threshold value, the charging/discharging control unit controls the auxiliary battery to perform the charging operation (S320).

As a result of the comparison in step S310, when the SOC of the auxiliary battery is larger than or equal to the pre-configured threshold value or when the SOC the auxiliary battery is smaller than the pre-configured threshold value and step S320 is performed, the allowable power calculation unit calculates the allowable power P_{MB} of the main battery based on the SOC of the main battery detected in step S300, the charging/discharging calculation unit calculates the charging/discharging power P_{SB} of the auxiliary battery performing the charging or discharging operation, and the first electric load power calculation unit calculates a first electric load power P_{L1}, which is power of an electric load item, execution of which has been requested by the driver (S330).

In brief, based on the SOC of the main battery detected in step S300, the allowable power calculation unit calculates the allowable power capable of supplying power to the electric load for a predetermined period of time. Further, based on an assumption that the electric load is configured to normally operate for five hours, if the power amount by the SOC of the main battery is detected as 1,000 [Wh], the allowable power calculation unit may calculate the allowable power as 200 [W].

However, according to a configuration, the allowable power calculation unit may maintain the allowable power or change the allowable power according to the changing SOC of the main battery. For example, as in the example described above, if the power amount by the SOC of the main battery is detected as 1,000 [Wh] and, thus, the allowable power calculation unit calculates the allowable power as 200 [W] and the electric load uses power of 200 Wh for one hour, the power amount by the SOC of the main battery after one hour may be 800 [Wh]. If the allowable power calculation unit is configured to maintain the allowable power, the calculated allowable power will be maintained as 200 [W] even in a situation in which the power amount by the SOC of the main battery is 800 [Wh]. In contrast, if the allowable power calculation unit is configured to change according to the changing SOC of the main battery, the allowable power calculated in the situation in which the power amount by the SOC of the main battery is 800 [Wh] may be 160 [W].

The charging/discharging power calculation unit calculates the charging/discharging power according to the charging/discharging operation of the auxiliary battery. The voltage for calculating the charging/discharging power is applied between the auxiliary battery and the main battery, and a voltage measured by a voltage sensor included in a converter maintaining the voltage of the electric load may be used as the voltage for calculating the charging/discharging power. Further, a current value measured by a current sensor included in a converter for controlling the charging/discharging operations of the auxiliary battery may be used as the current for calculating the charging/discharging power.

The first electric load power calculation unit may calculate the power consumption of an electric load, execution of which has been requested by the driver, based on power data of the electric load previously obtained through an experiment. Since the same operation of the electric load always requires the same power consumption, the power consumption of the electric load can be calculated based on the power data.

When step S330 has been completely performed, the operation control unit determines whether the sum of the charging/discharging power P_{SB} and the first electric load power P_{L1} exceeds the allowable power P_{MB} (S340).

When it is determined in step S340 that the sum of the charging/discharging power and the first electric load power does not exceed the allowable power, the operation control unit operates the electric load in response to a request from the driver (S350).

In contrast, when it is determined in step S340 that the sum of the charging/discharging power and the first electric load power exceeds the allowable power, the operation control unit controls an operation of the electric load, execution of which has been requested by the driver (S360).

For example, priorities are given to electric load items based on their influences on the power consumption and driving performance, and the operation control unit may control the electric load to firstly limit the power consumption of an electric load item having the lowest priority. When an electric load configured by a heater, a wiper, and a steering device is divided into two levels, the heater and the wiper may be classified as the lower level and the steering device may be classified as the higher level. Meanwhile, when the electric load is divided into three levels, the heater may be classified as the lowest level, the wiper may be classified as the middle level, and the steering device may be classified as the highest level.

When the electric load is divided into two levels, the operation control unit performing step S360 may control the power consumption of at least one of the heater and the wiper belonging to the lower level to be reduced. In contrast, when the electric load is divided into three levels, the operation control unit performing step S360 may control the power consumption of the heater or the heater and the wiper to be reduced according to the power difference between the allowable power and the sum of the charging/discharging power and the first electric load power.

On a condition that the sum of the charging/discharging power and the first electric load power is more than 30 [W] larger than the allowable power and the operation control of each of the heater and the wiper can save 20 [W], when the electric load is divided into two levels, the operation control unit may control the operation of each of the heater and the wiper to reduce power by 15 [W]. Otherwise, according to predetermined priorities, the operation control unit may firstly control the heater or wiper having the higher priority to reduce power by 20 [W] and then control the remaining heater or wiper to reduce power by 10 [W]. In contrast, when the electric load is divided into three levels, the operation control unit may firstly control the heater having the lowest priority to reduce power consumption by 20 [W] and then control the wiper having the middle priority to reduce power consumption by 10 [W].

As another example for reducing power consumption by controlling the operations of the electric load, the operation control unit may control the operation of an electric load item, execution of which has been requested by the driver, according to at least one method among the lowering of the operation level or the reduction of the operation time. When the driver requests operation of the heater, an electric load item, in the third level of the high temperature, the operation control unit may reduce the power consumption by operating the heater in a lowered level, that is, in the first or second level. Otherwise, instead of continuously operating the heater in the third level, the operation control unit may operate the heater in the third level for discrete time. That is, the operation control unit may operate the heater for discrete time by turning on the heater for a predetermined period of time and then turning off the heater for a predetermined period of time. The operation of the operation control unit in the example described above may be applied to other electric load items as well as the heater.

As another example for reducing power consumption by controlling the operations of the electric load, the operation control unit may control the electric load item to operate at dispersed time points. When a driver requests operation of the heater at the third level of a high temperature and operation of the wiper at the second level of a high speed, the operation control unit may control the heater and the wiper to operate for discrete times to reduce the power consumption of the electric load. That is, the operation control unit may control the heater to be turned on from the 0th to 5th second and to be turned off from the 5th to 10th second and control the wiper to be turned off from the 0th to 5th second and to be turned on from the 5th to 10th second, thereby reducing the power consumption of the electric load.

The operation of the operation control unit as described above can prevent frequent switching between charging and discharging of the auxiliary battery, thereby increasing the life span of the auxiliary battery.

After the execution of step S360 through the methods as described above, the second electric load power calculation unit calculates a second electric load power P_{L2}, which is power of an electric load item executed by the operation control unit (S370).

Based on power consumption data obtained through experiments previously performed according to various conditions for the electric load, the second electric load power calculation unit can calculate the second electric load power, which is power of an executed electric load item. In contrast, the second electric load power calculation unit can calculate the second electric load power by measuring the power of each electric load item being executed.

Thereafter, the charging/discharging control unit determines whether the sum of the charging/discharging power P_{SB} calculated in step S330 and the second electric load power P_{L2} calculated in step S370 exceeds the allowable power P_{MB} calculated in step S330 (S380).

When it is determined in step S380 that the sum of the charging/discharging power and the second electric load power exceeds the allowable power, the charging/discharging control unit controls the auxiliary battery, which is performing a charging operation, to perform a discharging operation (S390).

That is, the case where it is determined in step S380 that the sum of the charging/discharging power and the second electric load power exceeds the allowable power may be a case where the main battery has an insufficient SOC and thus has a low allowable power in spite of the maximal control of the operations of the electric load to make the power consumption of the electric load be as small as possible in step S360. Then, step S390 may be performed to not only prevent the main battery from being completely discharged but also normally operate the electric load having a large influence on the driving performance. An electric load item having a large influence on the driving performance may be an electric load item of the highest level in the electric load divided into two or more levels as described above.

Steps S300 to S390 described above may be partially modified or have some steps added thereto.

For example, in step S330, the allowable power calculation unit may predict the available time, based on the SOC of the main battery. Thereafter, the allowable power calculation unit calculates an allowable power proportional to the predicted available time.

Further, in step S360, when the available time does not exceed a predetermined reference, the operation control unit may first limit the power consumption of an electric load item having the lowest priority.

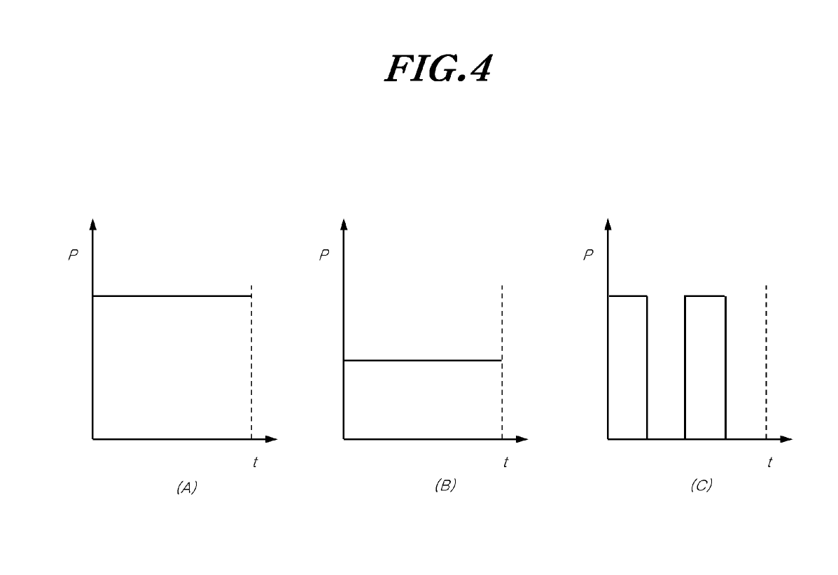

FIGS. 4A to 4C illustrate an example for describing the operation of an operation control unit according to an embodiment of the present disclosure.

FIGS. 4A to 4C show a waveform of power (P) consumed by an electric load according to time (t).

Referring to FIGS. 4A to 4C, an operation control unit according to an embodiment may change the power consumption of an electric load from a power consumption as shown in FIG. 4A to a power consumption as shown in FIG. 4B by controlling the electric load according to a method of lowering the operation level. Otherwise, the operation control unit according to an embodiment may change the power consumption of an electric load from a power consumption as shown in FIG. 4A to a power consumption as shown in FIG. 4C by controlling the electric load according to a method of reducing the operation time.

The graph illustrated in FIG. 4B is just an example and may include all cases of power consumption smaller than the power consumption of FIG. 4A. Also, the graph illustrated in FIG. 4C is just an example and does not require that the turned-on time of the electric load be always the same as the turned-off time thereof.

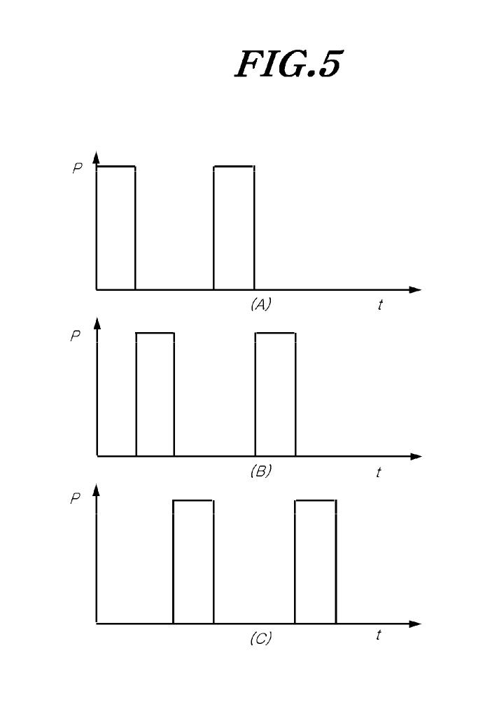

FIGS. 5A to 5C illustrate another example for describing the operation of an operation control unit according to an embodiment of the present disclosure.

FIGS. 5A to 5C show a waveform of power consumed by an electric load according to time, wherein the time axes of waveforms A, B, and C are the same.

Referring to FIGS. 5A to 5C, in controlling operations of three electric load items according to an embodiment, the operation control unit may control one electric load item to have a power consumption as shown FIG. 5A, control another electric load item to have a power consumption as shown FIG. 5B, and control another electric load item to have a power consumption as shown FIG. 5C.

As the operation control unit controls the electric load items to make the operation time points thereof be dispersed, the electric load items have power consumptions as shown in FIGS. 5A, 5B, and 5C, respectively. As a result, the main battery can consume a constant power and the life span of the main battery is ensured. In contrast, if the operation control unit controls the electric load items to make the operation time points thereof be the same, the main battery should discharge much power during the time in which the electric load operates while discharging small power during the time in which the electric load does not operate. In other words, the power discharged from the main battery may change according to time and may thus have a shortened life span.

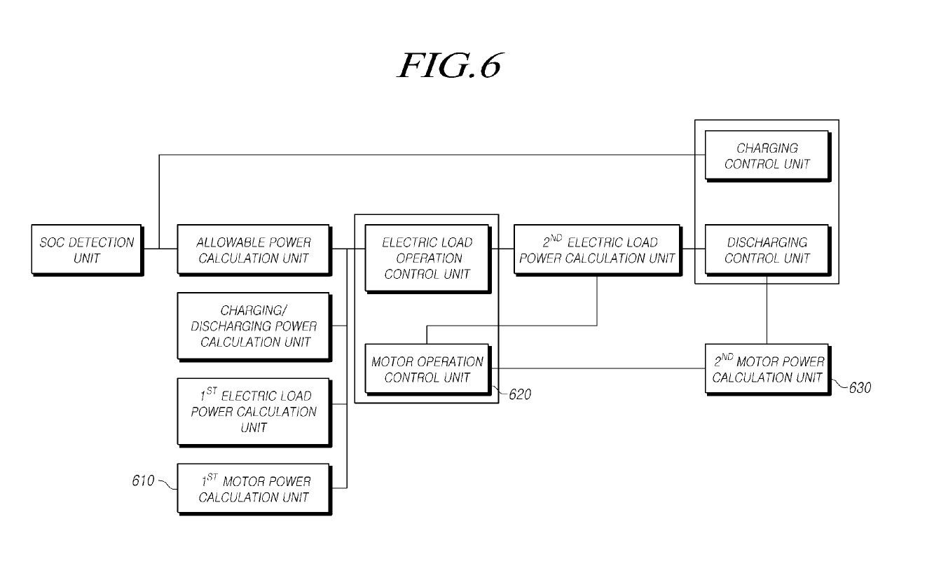

FIG. 6 illustrates a configuration of a power control apparatus according to another embodiment of the present disclosure.

A power control apparatus, according to another embodiment of the present disclosure, for controlling power of a vehicle apparatus, which includes a main battery, an auxiliary battery, and an electric load and includes a motor connected between the main battery and a road wheel of the vehicle to consume power at the time of a driving operation of the vehicle and produce power at the time of a braking operation of the vehicle, may include: an SOC detection unit configured to detect an SOC of the main battery and an SOC of the auxiliary battery; an allowable power calculation unit configured to calculate an allowable power of the main battery, based on the SOC of the main battery; a charging/discharging power calculation unit configured to calculate a charging/discharging power of the auxiliary battery performing a charging/discharging operation; a first electric load power calculation unit configured to calculate a first electric load power, which is power of an electric load, execution of which has been requested by a driver; a first motor power calculation unit configured to calculate power of the motor; an electric load operation control unit configured to control an operation of an electric load, execution of which has been requested based on the calculated allowable power, the charging/discharging power, the first electric load power, a first motor power; a second electric load power calculation unit configured to calculate a second electric load power, which is power of an electric load executed by the electric load operation control unit; a motor operation control unit configured to control an operation of the motor; a second motor power calculation unit configured to calculate a second motor power, which is power of the motor controlled by the motor operation control unit; and a charging/discharging control unit configured to control charging or discharging of the auxiliary battery, based on the SOC of the auxiliary battery, the allowable power, the charging/discharging power, and the second electric load power. The electric load operation control unit and the motor operation control unit described above may be a single operation control unit, and the charging/discharging control unit may be divided into a charging control unit and a discharging control unit.

In the configuration of the power control apparatus according to another embodiment as described above, the SOC calculation unit, the allowable power calculation unit, the charging/discharging power calculation unit, the first electric load power calculation unit, the electric load operation control unit, and the second electric load power calculation unit may be those of the power control apparatus according to the firstly described embodiment. Therefore, in the configuration of the power control apparatus according to an embodiment as described above, description of the SOC calculation unit, the allowable power calculation unit, the charging/discharging power calculation unit, the first electric load power calculation unit, the electric load operation control unit, and the second electric load power calculation unit will be partly omitted.

Referring to FIG. 6, the power control apparatus according to the another embodiment may further include a first motor power calculation unit 610 configured to calculate a first motor power, which is power of a motor that consumes power at the time of a driving operation of a vehicle and generates power at the time of a braking operation of the vehicle, in addition to the power control apparatus according to the firstly described embodiment.

The first motor power calculation unit 610 may detect the voltage and current of the motor according to the driving operation of braking operation of the vehicle and calculate the power using the detected voltage and current. In view of the load, the motor power may have a positive value when the vehicle performs a driving operation and a negative value when the vehicle performs a braking operation. In contrast, in view of the power, the motor power may have a negative value when the vehicle performs a driving operation and a positive value when the vehicle performs a braking operation. Regardless of the views of the load or power, the same result can be obtained. However, for the convenience of description, the motor power will be discussed hereinafter in view of the load.

The power control apparatus according to another embodiment may further include a motor operation control unit 620, in addition to the power control apparatus according to the firstly described embodiment. The motor operation control unit 620 together with the electric load operation control unit may be included in a single operation control unit, and the single operation control unit may firstly control the electric load and then control the motor. However, for the convenience of description and convenience of understanding, the single operation control unit is divided into the electric load operation control unit and the motor operation control unit 620 in the description.

The electric load operation control unit may control the execution-requested operation of the electric load, based on the allowable power, the charging/discharging power, the first electric load power, and the first motor power.

For example, if a sum of the charging/discharging power, the first electric load power, and the first motor power exceeds the allowable power, the electric load operation control unit may control the electric load to reduce the power consumed by the electric load.

The motor operation control unit 620 may control the operation of the motor, based on the allowable power, the charging/discharging power, the second electric load power, and the first motor power.

If a sum of the charging/discharging power, the second electric load power, and the first motor power exceeds the allowable power, the motor operation control unit 620 may control the power of the motor by reducing the output of the motor. For example, even when a driver requests 200 Revolutions Per Minute (RP_{M}) for the rotation of the motor by pressing an acceleration pedal, the motor operation control unit 620 may rotate the motor by 100 [RP_{M}], to reduce the power consumed by the motor.

The power control apparatus according to another embodiment may further include a second motor power calculation unit 630, in addition to the power control apparatus according to the firstly described embodiment.

The second motor power calculation unit 630 may be different from the first motor power calculation unit 610 in that the former calculates power consumed by a motor controlled by the motor operation control unit 620 while the latter calculates the first motor power, which is power consumed by a motor operating according to a request from the driver.

The discharging control unit may control the discharging of the auxiliary battery, based on the allowable power, the charging/discharging power, the second electric load power, and the second motor power.

For example, if a sum of the charging/discharging power, the second electric load power, and the second motor power exceeds the allowable power, the discharging control unit may control the auxiliary battery, which is performing the charging operation, to perform a discharging operation.

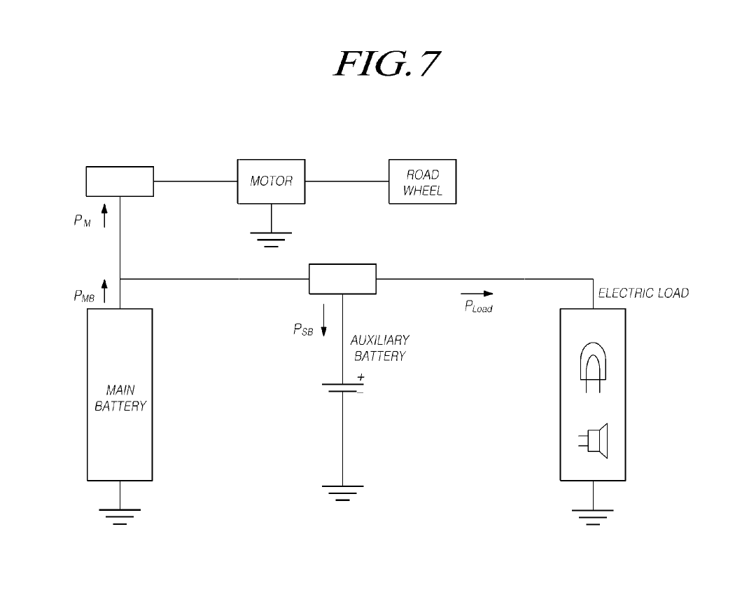

FIG. 7 illustrates an example for describing the operation of a power control apparatus according to another embodiment of the present disclosure.

A power control apparatus according to another embodiment of the present disclosure shown in FIG. 7 includes a motor connected between a main battery and a road wheel of a vehicle to consume power at the time of a driving operation of the vehicle and produce power at the time of a braking operation of the vehicle, in addition to the power control apparatus according to the embodiment of the present disclosure shown in FIG. 2. The following description mainly discusses the motor excluding the same elements as those of FIG. 2.

Referring to FIG. 7, a motor is connected between a main battery and a road wheel of a vehicle. Therefore, the power P_{MB} of the main battery may be a sum of the charging/discharging power P_{SB} of the auxiliary battery, the electric load power P_{LOAD}, and the motor power P_{M}.

P_{Load}+P_{SB}+P_{M}=P_{MB} Equation (2)

In equation (2), P_{M} has a positive value at the time of driving and a negative value at the time of braking.

Similarly to the description of FIG. 2, the power of the main battery may be determined by the power of the auxiliary battery directly controlled by a micro-controller, the power of the electric load, and the power of the motor.

Further, the power control apparatus may include a converter or an inverter according to whether the motor is a direct current motor or an alternating current motor. However, since the vehicle consumes power when performing the driving operation and generates power when performing the braking operation, both the converter and the inverter should be bidirectional.

Similarly to the power relation of the auxiliary battery, in view of the motor, the driving operation may consume a positive power and the braking operation may consume a negative power. In contrast, in view of a generator, the driving operation may generate a negative power and the braking operation may generate a positive power. Regardless of the views of both the motor and the generator, the same result can be obtained. However, for convenience of description, the description will be given in view of the motor, similarly to the auxiliary battery.

The power control apparatus according to another embodiment of the present disclosure may further include a first motor power calculation unit configured to calculate the motor power P_{M}, in addition to the power control apparatus according to the firstly described embodiment. The first motor power calculation unit may detect the voltage and current of the motor of an operating vehicle and calculate the power using the detected voltage and current.

The power control apparatus according to the another embodiment of the present disclosure may include an electric load operation control unit capable of adjusting the electric load power P_{LOAD} by controlling the electric load, and a motor operation control unit capable of adjusting the motor power P_{M} by controlling the motor.

The operation control unit of the power control apparatus according to the another embodiment of the present disclosure may firstly control the electric load and then control the motor.

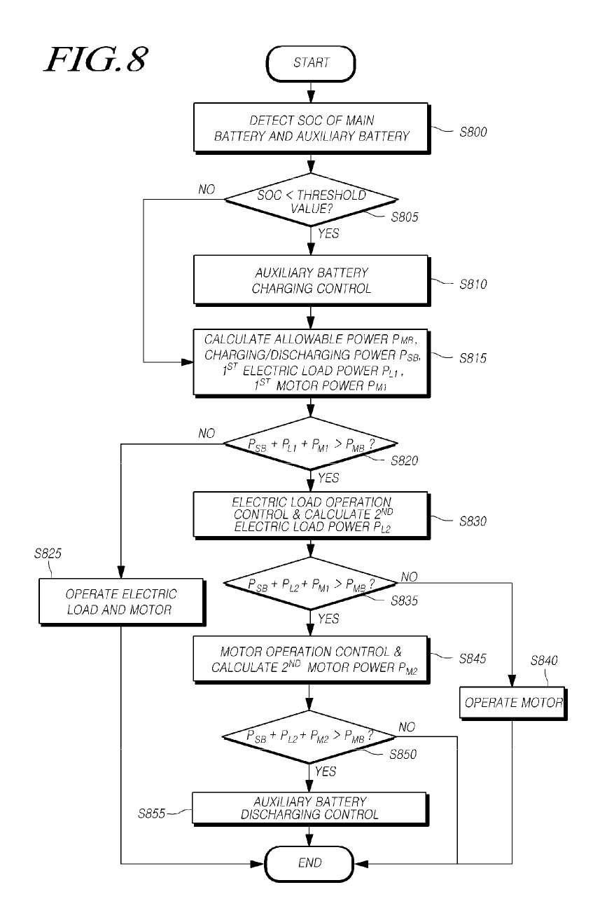

FIG. 8 illustrates another example for describing the operation of a power control apparatus according to another embodiment of the present disclosure.

A power control apparatus, according to another embodiment of the present disclosure, for controlling power of a vehicle, which includes a main battery, an auxiliary battery, and an electric load and includes a motor connected between the main battery and a road wheel of the vehicle to consume power at the time of a driving operation of the vehicle and produce power at the time of a braking operation of the vehicle, may include: a State Of Charge (SOC) detection unit configured to detect an SOC of the main battery and an SOC of the auxiliary battery; an allowable power calculation unit configured to calculate an allowable power of the main battery, based on the SOC of the main battery; a charging/discharging power calculation unit configured to calculate a charging/discharging power of the auxiliary battery performing a charging/discharging operation; a first electric load power calculation unit configured to calculate a first electric load power, which is power of an electric load, execution of which has been requested by a driver; a first motor power calculation unit configured to calculate a first motor power, which is power of the motor according to the operation of the vehicle; an operation control unit configured to control an operation of an electric load, execution of which has been requested based on the calculated allowable power, the charging/discharging power, the first electric load power, and a first motor power; a second electric load power calculation unit configured to calculate a second electric load power, which is power of an electric load executed by the electric load operation control unit; a second motor power calculation unit configured to calculate a second motor power, which is power of the motor controlled by the motor operation control unit; and a charging/discharging control unit configured to control charging or discharging of the auxiliary battery, based on the SOC of the auxiliary battery, the allowable power, the charging/discharging power, and the second electric load power.

In the description of the power control apparatus according to another embodiment of the present disclosure with reference to FIG. 8, the same or similar parts as those in the description of the power control apparatus according to the embodiment of the present disclosure with reference to FIG. 3 will be omitted.

Referring to FIG. 8, the SOC detection unit of the power control apparatus according to an embodiment of the present disclosure may detect the SOC of the main battery and the SOC of the auxiliary battery (S800).

The charging/discharging control unit determines whether the SOC of the auxiliary battery detected in step S800 is smaller than a pre-configured threshold value (S805).

When it is determined in step S805 that the SOC of the auxiliary battery is smaller than the pre-configured threshold value, the charging/discharging control unit controls the auxiliary battery to be charged (S810).

When it is determined in step S805 that the SOC of the auxiliary battery is larger than or equal to the pre-configured threshold value, or after step S810 is performed, the allowable power calculation unit, the charging/discharging power calculation unit, the first electric load power calculation unit, and the first motor power calculation unit calculate the allowable power P_{MB}, the charging/discharging power P_{SB}, the first electric load power P_{L1}, and the first motor power P_{M1}, respectively (S815).

For example, the first motor power calculation unit is connected between the main battery and a road wheel, and may measure the voltage applied between both terminals of a motor operated by a driver's request and the current flowing through the motor, and calculate the first motor power, which is the power of the motor, by multiplying the measured voltage applied between the terminals of the motor by the current flowing through the motor.

Thereafter, the operation control unit determines whether the sum of the first electric load power P_{L1} and the first motor power P_{M1} exceeds the allowable power P_{MB} (S820).

When it is determined in step S820 that the sum of the first electric load power P_{L1} and the first motor power P_{M1} is smaller than or equal to the allowable power P_{MB}, the operation control unit executes the electric load and the motor according to the driver's request (S825).

In contrast, when it is determined in step S820 that the sum of the charging/discharging power P_{SB}, the first electric load power P_{L1}, and the first motor power P_{M1} exceeds the allowable power P_{MB}, the operation control unit controls the operations of the electric load to reduce the power consumption thereof, and the second electric load power calculation unit calculates the second electric load power P_{L2}, which is power of an electric load item executed by the operation control unit (S830).

Then, the operation control unit determines whether the sum of the charging/discharging power P_{SB} calculated in step S815, the second electric load power P_{L2} calculated in step S830, and the first electric load power P_{L1} calculated in step S815 exceeds the allowable power P_{MB} calculated in step S815 (S835).

When it is determined in step S835 that the sum of the charging/discharging power P_{SB}, the second electric load power P_{L2}, and the first motor power P_{M1} is smaller than or equal to the allowable power P_{MB}, the operation control unit executes the motor according to the driver's request (S840).

In contrast, when it is determined in step S835 that the sum of the charging/discharging power P_{SB}, the second electric load power P_{L2}, and the first motor power P_{M1} exceeds the allowable power P_{MB}, the operation control unit controls the motor to reduce the power consumption thereof, and the second motor power calculation unit calculates the second motor power P_{M2}, which is power of the motor controlled by the operation control unit (S845).

According to an example of a method for reducing power consumption by controlling a motor, at the time of motor operation (driving operation), the motor may be controlled to have a motor output of 1,000 [RP_{M}] instead of 2,000 [RP_{M}] requested by the driver, which can reduce the power consumption of the motor. As another example, at the time of generator operation (braking operation), the motor may be controlled to have a motor output variance of 500 [RP_{M}] from 2,000 [RP_{M}], instead of a motor output variance of 1,000 [RP_{M}] from 2,000 [RP_{M}] requested by the driver. As a result, the power generation capability of the motor can be increased.

Then, the charging/discharging control unit determines whether the sum of the charging/discharging power P_{SB} calculated in step S815, the second electric load power P_{L2} calculated in step S830, and the second motor power P_{M2} calculated in step S845 exceeds the allowable power P_{MB} calculated in step S845 (S850).

When it is determined in step S850 that the sum of the charging/discharging power P_{SB}, the second electric load power P_{L2}, and the second motor power P_{M2} exceeds the allowable power P_{MB}, the operation control unit controls the auxiliary battery to perform a discharging operation (S855).

For example, in step S855, the auxiliary battery performing a charging operation may be controlled to perform a discharging operation.

As another example, in step S855, the auxiliary battery performing a discharging operation may be controlled to increase the discharging power.

Therefore, a power control apparatus according to an embodiment of the present disclosure can maintain the normal operation of the electric load having a large influence on the driving performance of a vehicle and prevent complete discharge of a main battery.

Hereinafter, a power control method performed by the power control apparatus described above with reference to FIGS. 1 to 8 will be briefly described.

A method for power control according to an embodiment of the present disclosure may include the steps of: installing a main battery, an auxiliary battery, and an electric load in parallel in a vehicle; detecting a State Of Charge (SOC) of the main battery and an SOC of the auxiliary battery; controlling charging of the auxiliary battery, based on the SOC of the auxiliary battery; calculating an allowable power of the main battery, based on the SOC of the main battery; calculating a charging/discharging power of the auxiliary battery performing a charging/discharging operation; calculating a first electric load power, which is power of an electric load, execution of which has been requested by a driver; controlling an operation of an electric load, execution of which has been requested, based on the allowable power, the charging/discharging power, and the first electric load power; calculating a second electric load power, which is power of an electric load executed in the operation control step; and controlling charging or discharging of the auxiliary battery, based on the allowable power, the charging/discharging power, and the second electric load power.

In the step of installing the main battery, the auxiliary battery, and the electric load in parallel in a vehicle, they may be installed as shown in FIG. 2.

The step of detecting an SOC of the main battery and an SOC of the auxiliary battery may be performed as step S300 of FIG. 3 for detecting an SOC of the main battery and an SOC of the auxiliary battery.

The step of controlling charging of the auxiliary battery, based on the SOC of the auxiliary battery may be performed as steps S310 to S320 of FIG. 3.

The steps of calculating the allowable power of the main battery, based on the SOC of the main battery, calculating the charging/discharging power of the auxiliary battery performing a charging/discharging operation, and calculating the first electric load power, which is power of an electric load, execution of which has been requested by a driver may be performed as step S330 of FIG. 3.

The step of controlling an operation of an electric load, execution of which has been requested based on the allowable power, the charging/discharging power, and the first electric load power may be performed as steps S340 to S360 of FIG. 3.

The step of calculating the second electric load power, which is power of an electric load executed by the operation control unit may be performed as step S370 of FIG. 3.

Finally, the step of controlling charging or discharging of the auxiliary battery, based on the allowable power, the charging/discharging power, and the second electric load power may be performed as steps S380 to S390 of FIG. 3.

In addition, the power control method according to the present disclosure may include all operations performed by the power control apparatus according to the present disclosure described above with reference to FIGS. 1 to 8.

Even if it was described above that all of the components of an embodiment of the present invention are coupled as a single unit or coupled to be operated as a single unit, the present invention is not necessarily limited to such an embodiment. That is, at least two elements of all structural elements may be selectively joined and operate without departing from the scope of the present invention. Although a preferred embodiment of the present invention has been described for illustrative purposes, those skilled in the art will appreciate that various modifications, additions and substitutions are possible, without departing from the scope and spirit of the invention as disclosed in the accompanying claims. The scope of the present invention shall be construed on the basis of the accompanying claims in such a manner that all of the technical ideas included within the scope equivalent to the claims belong to the present invention.

What is claimed is:

1. An apparatus for controlling power of a vehicle including a main battery, an auxiliary battery, and an electric load, the apparatus comprising:
a State Of Charge (SOC) detection unit configured to detect an SOC of the main battery and an SOC of the auxiliary battery;
an allowable power calculation unit configured to calculate an allowable power of the main battery, based on the SOC of the main battery;
a charging/discharging power calculation unit configured to calculate a charging/discharging power of the auxiliary battery performing a charging or discharging operation;
a first electric load power calculation unit configured to calculate a first electric load power, which is power of an electric load, execution of which has been requested by a driver;
an operation control unit configured to control an operation of the electric load, execution of which has been requested, based on the allowable power, the charging/discharging power, and the first electric load power;
a second electric load power calculation unit configured to calculate a second electric load power, which is power of the electric load executed by the operation control unit; and
a charging/discharging control unit configured to control charging or discharging of the auxiliary battery, based on the SOC of the auxiliary battery, the allowable power, the charging/discharging power, and the second electric load power.

2. The apparatus of claim 1, wherein each electric load item of the electric load is allocated a priority based on power consumption and an influence on driving performance.

3. The apparatus of claim 2, wherein the operation control unit firstly limits power consumption of an electric load item having the lowest priority when an available time predicted based on the SOC of the main battery is smaller than or equal to a predetermined time.

4. The apparatus of claim 2, wherein the electric load comprises a heater having the lowest priority, a wiper having a middle priority, and a steering device having the highest priority.

5. The apparatus of claim 1, wherein the operation control unit controls an operation of the electric load, execution of which has been requested, by at least one method among lowering of an operation level and reduction of an operation time.

6. The apparatus of claim 1, wherein when a sum of the charging/discharging power and the first electric load power exceeds the allowable power, the operation control unit controls the operation of the electric load to make a sum of the charging/discharging power and a power consumed by the electric load be smaller than or equal to the allowable power, in order to prevent switching between charging and discharging of the auxiliary battery.

7. The apparatus of claim 1, wherein the allowable power calculation unit calculates an allowable power proportional to the SOC of the main battery.

8. The apparatus of claim 1, wherein when a sum of the charging/discharging power and the first electric load power exceeds the allowable power, the operation control unit controls the operation of the electric load, execution of which has been requested.

9. The apparatus of claim 1, wherein the allowable power calculation unit predicts an available time based on the SOC of the main battery.

10. The apparatus of claim 1, wherein the operation control unit controls the electric load, execution of which has been requested, to operate at dispersed time points.

11. The apparatus of claim 1, wherein when the SOC of the auxiliary battery is lower than a pre-configured threshold value, the charging/discharging control unit controls the auxiliary battery to be charged.

12. The apparatus of claim 1, wherein when a sum of the charging/discharging power and the second electric load power exceeds the allowable power, the charging/discharging control unit controls the auxiliary battery to be discharged.

13. The apparatus of claim 1, further comprising:
a motor connected between the main battery and a road wheel of the vehicle to consume power at the time of a driving operation of the vehicle and produce power at the time of a braking operation of the vehicle;
a first motor power calculation unit configured to calculate a first motor power, which is power of the motor; and
a second motor power calculation unit configured to calculate a second motor power, which is power of the motor controlled by the motor operation control unit,
wherein the operation control unit firstly controls the operation of the electric load, execution of which has been requested, based on the allowable power, the charging/discharging power, the first electric load power, and the first motor power.

14. The apparatus of claim 1, further comprising:
a motor connected between the main battery and a road wheel of the vehicle to consume power at the time of a driving operation of the vehicle and produce power at the time of a braking operation of the vehicle;
a first motor power calculation unit configured to calculate a first motor power, which is power of the motor; and
a second motor power calculation unit configured to calculate a second motor power, which is power of the motor controlled by the motor operation control unit,
wherein the operation control unit secondarily controls the operation of the motor, based on the allowable power, the charging/discharging power, the second electric load power, and the first motor power.

15. The apparatus of claim 1, further comprising:
a motor connected between the main battery and a road wheel of the vehicle to consume power at the time of a driving operation of the vehicle and produce power at the time of a braking operation of the vehicle;
a first motor power calculation unit configured to calculate a first motor power, which is power of the motor; and
a second motor power calculation unit configured to calculate a second motor power, which is power of the motor controlled by the motor operation control unit,
wherein the charging/discharging control unit controls charging or discharging of the auxiliary battery, based on the SOC of the auxiliary battery, the allowable power, the second electric load power, and the second motor power.

16. A power control method comprising:
installing a main battery, an auxiliary battery, and an electric load in parallel in a vehicle;
detecting a State Of Charge (SOC) of the main battery and an SOC of the auxiliary battery;
controlling charging of the auxiliary battery, based on the SOC of the auxiliary battery;
calculating an allowable power of the main battery, based on the SOC of the main battery;
calculating a charging/discharging power of the auxiliary battery performing a charging or discharging operation;
calculating a first electric load power, which is power of an electric load, execution of which has been requested by a driver;
controlling an operation of an electric load, execution of which has been requested, based on the allowable power, the charging/discharging power, and the first electric load power;
calculating a second electric load power, which is power of an electric load executed in the operation controlling; and
controlling charging or discharging of the auxiliary battery, based on the allowable power, the charging/discharging power, and the second electric load power.
